(19) United States
(12) Patent Application Publication
(10) Pub. No.: US 2025/0044401 A1
(43) Pub. Date: Feb. 6, 2025

(54) SYSTEM AND METHOD FOR FINDING A Kth ELEMENT IN A SERIES OF VALUES IN A DETECTOR

(71) Applicant: Ceva D.S.P. Ltd., Herzlia Pituach (IL)

(72) Inventor: Zeev KAPLAN, Rosh Ha-ayin (IL)

(73) Assignee: Ceva D.S.P. Ltd., Herzlia Pituach (IL)

(21) Appl. No.: 18/361,973

(22) Filed: Jul. 31, 2023

(51) Int. Cl. G01S 7/02

(52) U.S. Cl. CPC G01S 7/021

(57) ABSTRACT

A method and system for finding a K^{th} element in a series of values, including: organizing the series of values in a PDF by counting a number of occurrences of each value of the series of values; organizing the series of values in a CDF that includes adjacent bins of ranges of values, by counting for each bin an accumulated number of occurrences of values of the series of values up to a bin index of that bin; finding in the CDF a bin for which the associated accumulated number of occurrences is a largest accumulated number of occurrences among the accumulated number of occurrences that is smaller than K; and finding the K^{th} largest element by searching the PDF for the K^{th} largest element, starting from the found bin index.

### FIELD OF THE INVENTION

Embodiments of the present invention relate generally to finding a k^{th} element in a series of values, and more particularly to finding a k^{th} element in a series of values to be used in an order statistics constant false-alarm rate (OS-CFAR) detector.

### BACKGROUND OF THE INVENTION

Current Radar and Lidar systems may use a constant false-alarm rate (CFAR) detector to detect targets against a background signal composed of clutter, interference and noise. CFAR detectors require finding an adaptive threshold, also referred to as the power threshold, for each cell under test (CUT). The adaptive threshold may be used to determine the presence of a target in the CUT. e.g., by comparing the CUT to the adaptive threshold.

Various types of CFAR detectors are known. In cell averaging CFAR (CA-CFAR) detectors the threshold is calculated by averaging cells around the CUT, which is a linear operation. In an ordered-statistic constant false-alarm rate (OS-CFAR) detectors, however, a non-linear detection schemes may be applied to targets detection in cluttered environment (e.g., multi-targets). This type of detector is useful and being applied in civil and military applications as well.

Calculating an adaptive threshold for a CUT in an OS-CFAR detector involves finding a k^{th} element in reference window. e.g., in a block of cells around the CUT. In some applications the k^{th} element is the median, however other k^{th} elements may be selected. The selected k^{th} element may then be used to determine the adaptive threshold.

Finding a k^{th} element in a series of samples typically requires sorting the values in the series, which is a non-linear and computationally intensive operation, that has to be performed for each CUT. Therefore, an efficient method for finding a e element in a series of values is required.

### SUMMARY OF THE INVENTION

According to embodiments of the invention, a system and method for finding a K^{th} element in a series of values may include using a processor: organizing the series of values in a probability distribution histogram by finding a number of occurrences of each value of the series of values; organizing the series of values in a decimated accumulated histogram, wherein the decimated accumulated histogram includes adjacent bins of ranges of values; performing a coarse search on the decimated accumulated histogram; and performing a fine search in the probability distribution histogram, based on results of the coarse search.

According to embodiments of the invention, organizing the series of values in the decimated accumulated histogram may include finding for each bin an accumulated number of occurrences of values of the series of values up to a bin index of that bin, where the bin index may be a maximal value included in the bin; performing the coarse search on the decimated accumulated histogram may include finding in the decimated accumulated histogram a bin for which the associated accumulated number of occurrences is a largest accumulated number of occurrences among the accumulated number of occurrences that is smaller than K; and performing the fine search in the probability distribution histogram may include searching the probability distribution histogram for the Kth smallest element, starting from the bin index of the found bin.

According to embodiments of the invention, organizing the series of values in the decimated accumulated histogram may include finding for each bin, an accumulated number of occurrences of values of the series of values down to a bin index of that bin, where the bin index is a minimal value included in the range of values of the bin; performing the coarse search on the decimated accumulated histogram may include finding in the decimated accumulated histogram a bin for which the associated accumulated number of occurrences is a largest accumulated number of occurrences among the accumulated number of occurrences that is smaller than K; and performing the fine search in the probability distribution histogram may include searching the probability distribution histogram for the Kth largest element, starting from the bin index of the found bin.

According to embodiments of the invention, the bins of the decimated accumulated histogram may be equally spaced.

According to embodiments of the invention, the bins of the decimated accumulated histogram may be spaced based on a-priory knowledge of statistics of the series of values.

According to embodiments of the invention, the series of values may include values of a window of an ordered-statistic constant false-alarm rate (OS-CFAR) detector, and an example embodiment may include using the Kth smallest element or the Kth largest element to detect targets by the OS-CFAR detector.

According to embodiments of the invention, the bins may be spaced based on the Kth smallest element or the K^{th} largest element, and a distribution of the series of values of previous OS-CFAR windows.

According to embodiments of the invention, a format of the values of the series of values may be unsigned 8-bit integer.

Embodiments of the invention may include: obtaining a second series of values; selecting a subblock of bits of each value of the second series of values to generate a narrow series of values; finding a first K^{th} largest element of the narrow series of values; repeating the selecting and finding until a required precision in finding a general K^{th} order element is achieved; and combining the K^{th} largest elements to obtain the general K^{th} largest element.

Embodiments of the invention may include: obtaining a series of unsigned integers, each of a*b eight bits, where a and b are integer numbers larger than 1; performing a log₂ operation on the series of the unsigned integers and extracting an integer part of the result to obtain a first series of values; finding a first K^{th} largest element of the first series of values to obtain KStat_exp; scaling the series of unsigned integers by shifting left with saturation each of the unsigned integers by KStat_exp to obtain a shifted series; extracting eight most significant bits (MSBs) of the shifted series; finding a second K^{th} largest element for the MSBs of the shifted series to obtain KStat_HighBits; and approximating a general K^{th} smallest element of the series of unsigned integers by calculating KStat_HighBbits×2^{(Ks tat_exp+exp_bias)}.

Embodiments of the invention may include: obtaining a series of floating-point numbers; extracting an exponent of each of the floating-point numbers of the series of floating-point numbers to obtain a series of exponents; finding a first K^{th} smallest element of the series of exponents to obtain KStat_exp; finding in the series of floating-point numbers floating-point numbers with exponent of KStat_exp; extracting a set of most significant bits (MSBs) of a mantissa of the floating-point numbers with exponent of KStat_exp to generate a series of MSBs; finding a second K^{th} smallest element of the series of MSBs to obtain KStat_HighBits; and approximating a general K^{th} smallest element of the series of floating-point numbers by calculating KStat_HighByte×2^{(Ks tat_exp+exp_bias)}.

According to embodiments of the invention, the set of MSBs may include eight bits.

Embodiments of the invention may include: obtaining a series of unsigned integers, each of a*b bits, where a and b are integer numbers larger than 1; extracting a subblock of b most significant bits (MSBs) of each unsigned integer of the series of unsigned integers to obtain a series of MSBs; finding a first K^{th} smallest element of the series of MSBs to obtain KStat_MSB; finding in the series of unsigned integers, unsigned integers with MSBs that equal KStat_MSB to generate a series of candidates; and repeating for each consecutive subblock of b bits of the unsigned integers: if the series of candidates include a number of unsigned integers that is below a threshold than: performing a linear search on the series of candidates to find a general K^{th} smallest element of the series of unsigned integers; otherwise: extracting a subblock of b bits following the previous extracted subblock of b bits of each integer of the series of candidates to obtain a series of subblocks; finding a following K^{th} smallest element of the series of subblock to obtain KStat_subblock; and if the extracted subblock includes the least significant bits (LSB), combining the KStat_MSB with the KStat_subblocks to generate the general K^{th} smallest element of the series of unsigned integers and otherwise leaving in the series of candidates, only candidates with the subblock of b bits that equal KStat_subblock

According to embodiments of the invention, a system and method for finding a K^{th} element in a series of values may include using a processor: extracting a subblock of bits from each value of the series of values to generate a narrow series of values; finding a first K^{th} order element of the narrow series of values; repeating the extracting and finding until a required precision in finding a general K^{th} order element is achieved; and combining the first Kth order elements to obtain the general K^{th} order element.

According to embodiments of the invention, the elements of the series of values may be provided in unsigned integer format; where embodiments may include, in a first repetition: selecting comprises performing a log₂ operation on the series of the unsigned integers and extracting an integer part of the result to obtain the first narrow series of values; and finding the first K^{th} largest element of the first narrow series of values is performed to obtain KStat_exp; and in a second repetition: selecting comprises scaling the series of unsigned integers by shifting left with saturation each of the unsigned integers by KStat_exp to obtain a shifted series; and extracting a plurality of most significant bits (MSB) of the shifted series; and where finding a second K^{th} largest element for the MSB of the shifted series may be performed to obtain a second KStat_HighBits; where combining may include approximating a general K^{th} largest element of the series of unsigned integers by calculating KStat_HighBbits×2^{(KStat_exp+exp_bias)}.

According to embodiments of the invention, the series of values may include a series of floating-point numbers; where embodiments may include, in a first repetition: selecting comprises extracting an exponent of each of the floating-point numbers of the series of floating-point numbers to obtain a series of exponents; and finding a first K^{th} largest element of the series of exponents is performed to obtain a first KStat_exp; and in a second repetition: selecting comprises finding in the series of floating-point numbers floating-point numbers with an exponent equal to KStat_exp, and extracting a set of most significant bits (MSB) of a mantissa of the floating-point numbers with exponent of KStat_exp to generate a series of MSBs; and finding a second K^{th} largest element of the series of MSBs is performed to obtain a second KStat_HighBits; where combining comprises approximating a general K^{th} largest element of the series of floating-point numbers by calculating KStat_HighBbits×2^{(KStat_exp+exp_bias)}.

According to embodiments of the invention, the set of MSBs may include eight bits.

According to embodiments of the invention, the series of values may include unsigned integers, each of a*b bits, where a and b are integer numbers larger than 1; where embodiments may include in a first repetition: selecting comprises extracting a subblock of b most significant bits (MSB) of each unsigned integer of the series of unsigned integers to obtain a series of MSBs; and finding a first K^{th} largest element of the series of MSBs is performed to obtain KStat_MSB; embodiments may further include finding in the series of unsigned integers, unsigned integers with MSBs that equal KStat_MSB to generate a series of candidates; and if the series of candidates include a number of unsigned integers that is below a threshold than: performing a linear search on the series of candidates to find a general K^{th} largest element of the series of unsigned integers; and otherwise, repeating the selecting and finding comprises repeating for each consecutive subblock of b bits of the unsigned integers: extracting a subblock of b bits following the previous extracted subblock of b bits of each integer of the series of candidates to obtain a series of subblock of b bits; finding a following K^{th} largest element of the series of subblock of b bits to obtain KStat_subblock; and if the extracted byte includes the least significant bits (LSB), combining the KStat_MSB with the KStat_subblocks to generate the general K^{th} largest element of the series of unsigned integers and otherwise leaving in the series of candidates, only candidates with the subblock of b bits that equal KStat_subblock.

Embodiments of the invention may include finding the first K^{th} largest element in the narrow series of values, by: organizing the narrow series of values in a histogram by counting a number of occurrences of each value of the narrow series of values; organizing the narrow series of values in a decimated accumulated histogram, where the decimated accumulated histogram includes adjacent bins of ranges of values, and where organizing the narrow series of values may include counting for each bin an accumulated number of occurrences of values of the narrow series of values up to a bin index, where the bin index is a maximal value included in the bin; finding in the decimated accumulated histogram a bin for which the associated accumulated number of occurrences is a largest accumulated number of occurrences among the accumulated number of occurrences that is smaller than K; and searching the probability distribution histogram for the K^{th} element, starting from the found bin index.

According to embodiments of the invention, the bins may be equally spaced.

According to embodiments of the invention, the bins may be spaced based on a-priory knowledge of a possible range of the K^{th} largest element.

According to embodiments of the invention, the series of values may be values of an ordered-statistic constant false-alarm rate (OS-CFAR) window of a detector, and an example embodiment may include using the K^{th} largest element to detect targets by the OS-CFAR detector.

According to embodiments of the invention a format of the values of the narrow series of values may be unsigned 8-bit integer.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a schematic illustration of a detection and ranging system, according to embodiments of the invention;

FIG. 2 is a schematic illustration of a simplified block diagram of an OS-CFAR detector, according to embodiments of the invention;

FIG. 3 is a schematic illustration of a two-dimensional reference window, helpful in explaining embodiments of the invention;

FIG. 4 is a high-level flowchart illustrating a first method for finding the K^{th} element in a series of values, according to embodiments of the invention;

FIG. 5 is an example of a full probability distribution histogram for 8-bits unsigned integer PDF, according to embodiments of the invention;

FIG. 6 is a high-level flowchart illustrating a method for finding the K^{th} order element in a series of values, according to embodiments of the invention,

FIG. 7 is a high-level flowchart illustrating a method for estimating the K^{th} order element in a series of values provided in unsigned integer format, according to embodiments of the invention;

FIG. 8 is a high-level flowchart illustrating a method for estimating the K^{th} order element in a series of values provided in floating point format, according to embodiments of the invention;

FIG. 9 is a high-level flowchart illustrating a method for finding the K^{th} order element in a series of values provided in integer format, according to embodiments of the invention;

FIG. 10 is a high-level flowchart illustrating a method for finding the K^{th} order element in a series of 32-bit unsigned integers, according to embodiments of the invention;

FIG. 11 is an exemplary series of 32-bit unsigned integer format elements, according to embodiments of the invention;

FIG. 12 is a high-level flowchart illustrating a method for finding the K^{th} order element in a series of floating point numbers, according to embodiments of the invention;

FIG. 13 is an exemplary series of single-precision floating-point number format elements, according to embodiments of the invention; and

FIG. 14 is schematic illustration of an exemplary device according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

As used herein an integer format or an integer representation, may refer to a numeric data type or data representation in computer science including integer and unsigned integer data types in various bit lengths, and an integer number may refer a whole number (e.g., the common definition of integer numbers in the field of mathematics). Floating point format or numbers may refer to the known representation of numbers in computer science that includes a fixed number of significant digits (referred to as mantissa or significand) that is scaled by an exponent in a fixed base (an integer greater than or equal to two, typically two, ten, or sixteen), where the mantissa and exponent are integer numbers and:

$$floating point number = {mantissa * base}^{exponenet}$$

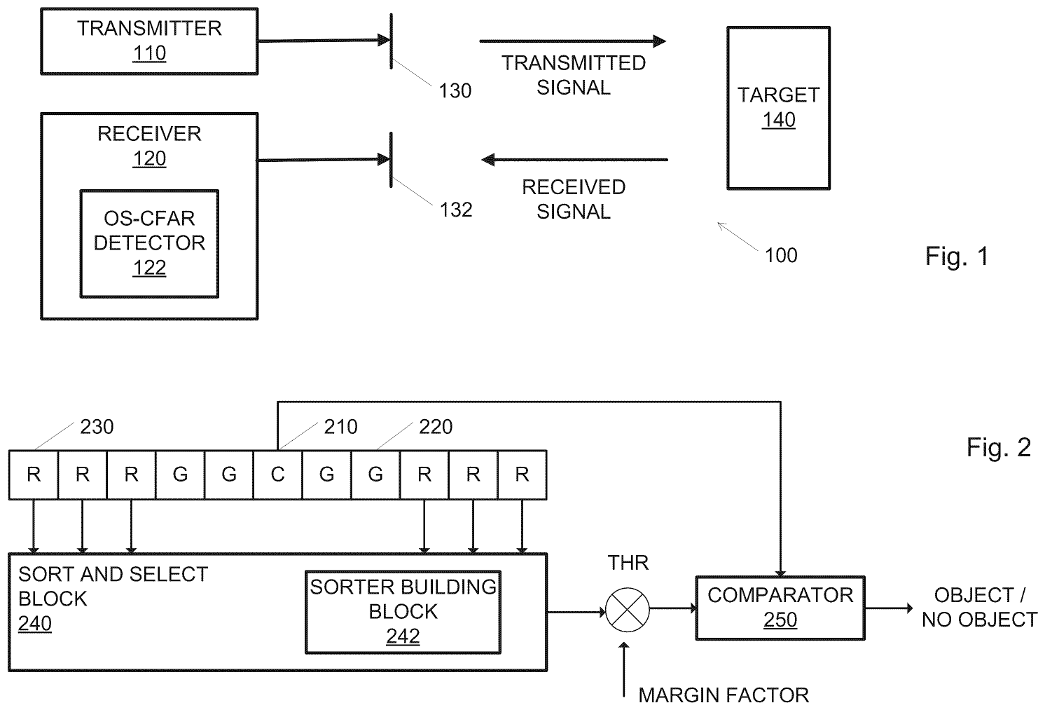

Reference is now made to FIG. 1 which is a schematic illustration of a detection and ranging system 100, according to embodiments of the invention. System 100 may be any detection system that transmits electromagnetic (EM) signals and/or acoustic waves (waves that occur as the propagated mechanical vibration of particles in a medium) and studies the reflected back waves. For example, the EM waves may include radio frequency (RF) waves. System 100 may include a RADAR system, a Lidar system, or any other system that transmits and receives EM signals, e.g., RF waves, and/or acoustic waves for detecting target 140 and calculates the distance from target 140 by comparing the time it takes for the outgoing EM signals and/or acoustic waves to return to from transmitter 110 to receiver 120.

System 100 may include transmitter 110 and receiver 120 that may transmit EM. e.g., RF waves using transmit antenna 130 and receive reflected waves using receive antenna 132. Transmitter 110 may transmit EM (e.g., RF) waves and/or acoustic waves. The transmitted EM/RF/acoustic waves may hit a target 140 and be reflected in various directions. The signal which is reflected back towards receive antenna 132 may be received by receiver 120. While two separate antennas 130 and 132 are depicted in FIG. 1, this is not limiting and a plurality of either transmit antennas 130 and/or receive antennas 132 may be used, or a single antenna may be used for both transmitting and receiving the EM/RF/acoustic waves. The presence or non-presence of a target 140, and the distance of target 140 if present, may be studied by receiver 120 based on the received signal. Receiver 120 may include an ordered-statistic constant false-alarm rate (OS-CFAR) detector 122. Receiver 120 may receive the EM/RF/acoustic waves, and may process the EM/RF/acoustic waves to calculate various aspects of the receives signal such as post range processing, doppler processing, angular processing, etc. Receiver 120 may create a processed signal data cube (or a frequency spectrum) of multiple dimensions, e.g., for Radar signal a two-dimensional (2D) range-doppler maps or higher dimensional maps also presenting, for example, spatial dimensions azimuth/elevation and more may be generated. OS-CFAR detector 122 may receive the processed Radar data cube, t the entire signal data cube or a part of the signal data cube may be taken as the reference window of the received signal. The frequency spectrum may be divided into frequency bins, where a frequency bin of the frequency spectrum may correspond to a specific range of an object. Each of the frequency bins, also referred to as range cells, or simply as cells, may be analyzed to determine whether an object is located in this cell (e.g., the CUT) or not.

According to embodiments of the invention, OS-CFAR detector 122 may calculate an adaptive threshold for a CUT based on a K^{th} order element or K^{th} order statistic in the reference window surrounding the CUT, where K is a natural number equal or smaller than the number of elements in the reference window. For example, an adaptive threshold may be the median of the reference window, or the median multiplied by a margin factor.

Embodiments of the invention may provide an improved method for finding the K^{th} order element or statistic. Embodiments of the invention may require less processing power and less memory for finding the K^{th} order element in a series of computerised numbers or values, and therefore may improve the performance of a processor or other computing hardware used for finding the K^{th} order element. Additionally, embodiments of the invention may improve the technology of OS-CFAR detectors, and other applications that require computationally finding a K^{th} element in a series of values.

While embodiments of the invention are demonstrated with relation to a RADAR or a LiDAR system, this is not limiting, and embodiments of the invention may be utilized in any OS-CFAR detector. Additionally, embodiments of the invention may apply to any application that requires finding a K^{th} element in a series of values or numbers.

Reference is now made to FIG. 2 which is a schematic illustration of OS-CFAR detector 122, according to embodiments of the invention. OS-CFAR detector 122 may obtain a one-dimension (1D) reference window 200 that may include CUT 210 (marked as ‘C’ in FIG. 2), which is the cell for which detection is required. CUT 210 may be located at the center of reference window 200. In some applications, the cells immediately surrounding CUT 210 may be referred to as guard cells 220 (marked as ‘G’ in FIG. 2). Reference cells 230 (marked as ‘R’ in FIG. 2) surrounding CUT 210 further from guard cells 220, may be used by OS-CFAR detector 122 for calculating an adaptive threshold or power threshold. In order to determine the presence of a target in CUT 220. OS-CFAR detector 122 may find or calculate an adaptive threshold or power threshold for reference window 200. In some applications, the power threshold may be calculated based on reference cells 230, and guard cells 220 may be eliminated and not used for this calculation, depending on the application.

In some implementation of OS-CFAR detector 122, finding or calculating the threshold or power threshold may include finding a K^{th} order statistic among reference cells 230. e.g., finding the K^{th} largest or K^{th} smallest element. In one embodiment, a straightforward way to find the K^{th} order statistic may include sorting all the elements, e.g., all reference cells 230 in ascending order and picking the K^{th} element. For example, in a series of values in[n], in length N, e.g., N is the number of elements to sort, where n=0, 1, 2, . . . , N−1, and N is an integer number larger than 1, the straightforward way to find the K^{th} smallest element may include sorting all the elements to obtain a sorted series of values sorted_in[n], such that sorted_in[0]≤sorted_in[1]≤ . . . ≤sorted_in[N−1], and the K^{th} smallest element would be sorted_in[K−1], e.g., if K=1 the smallest element will be selected which is sorted_in[0], if K=2 the second smallest element will be selected which is sorted_in[1], etc. Similarly, the straightforward way to find the K^{th} largest element may include sorting all the elements to obtain a sorted series of values sorted_in2[n], such that sorted_in2[0]≥sorted_in2[1]≥ . . . ≥sorted_in2[N−1], and the K^{th} largest element would be sorted_in2[K−1]. e.g., if K=1 the largest element will be selected which is sorted_in2[0], if K=2 the second largest element will be selected which is sorted_in2[1], etc.

It should be readily understood by those skilled in the art the tasks of finding the K^{th} largest element and finding the K^{th} smallest element are equivalent tasks that may be performed using similar logic. In addition, finding the K^{th} largest element is equivalent to filing the (N-K+1)^{th} smallest element, and vice versa. Both tasks may be referred to herein as finding the Km order element.

Finding the K^{th} order element using prior art methods is computationally intensive. In general sorting is a highly complex and computationally intensive task. Since finding the K^{th} order element should be repeated for substantially each CUT, this complexity can pose a real problem for detector 122. Nondeterministic generic sorting algorithms have complexity in order of O(N·log N) and different performance of average and worst-case scenarios. Other more specific algorithms e.g., Radix Sort, adapted for fixed length integer keys are deterministic in performance. Embodiments of the invention may provide a more efficient way for finding the K^{th} ordered statistic in a string of elements, e.g., in reference cells 230 or for complete sorting of the string of elements for different data types and input lengths. Embodiments of the invention may further provide optional low complexity alternative of finding an approximated K^{th} statistic or sorting a string of elements with lower precision that may fit the detection requirements with substantially reduced complexity.

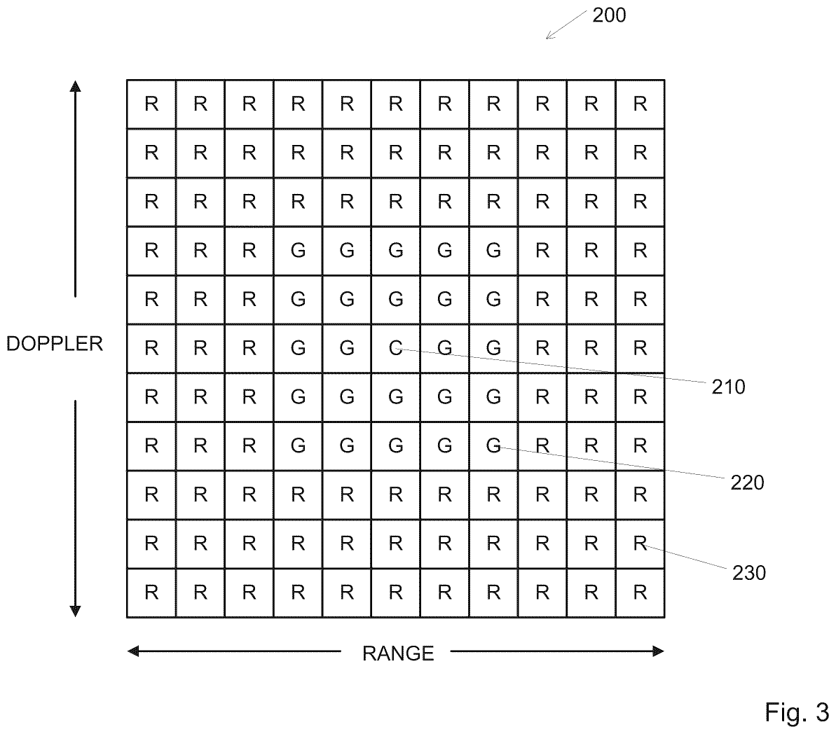

A second example of a reference window is presented in FIG. 3 which is a schematic illustration of a 2D reference window 300, also referred to as a 2D CFAR window, helpful in explaining embodiments of the invention. A first dimension in reference window 300 may represent range, and the second dimension may represent Doppler. While FIG. 3 shows a rectangular window, embodiments of the invention may be used for other 2D OS-CFAR reference windows as well as for 1D (e.g., reference widow 200) and three-dimensional (3D) reference windows. For example, a 3D reference window may include range-Doppler-angle dimensions, and a 4D reference window may include range, doppler, azimuth and elevation dimensions. The reference window may be rectangular or have other shapes of windows, such as plus sign ‘+’ like, x like etc.

According to embodiments of the invention, a series of values e.g., reference cells 230 of reference windows 200 or 300, or other series of values may be provided to sort and select block 240 that may find the K^{th} order statistic (e.g., the K^{th} largest or K^{th} smallest value) of the input series of values, e.g., of reference cells 230.

According to embodiments of the invention, sort and select block 240 may find the K^{th} order statistic using one or more sorter building blocks 242, for example, the sorter building block 242 may sort values provided in integer format, e.g., 8-bit integer format or other integer formats with other number of bits. The sort and select block 240 may use more than one sorter building blocks 242 to find a K^{th} order statistic of other data types such as integers formats with more bits. e.g., 16, 32, 64, 128 etc. integer formats, floating point numbers and other number formats as required.

According to embodiments of the invention, sorter building block 242 may find the K^{th} order statistic by building histograms, referred to herein as a probability distribution histogram (PDF) and a decimated accumulated histogram, referred to herein as CDF. Both the PDF and CDF may present the distribution of numerical data (e.g., the series of elements or values) in various ranges of intervals, also referred herein as PDF bins. According to embodiments of the invention, each range of intervals in the PDF or PDF bin, may include a single possible value of the series of elements or values, while ranges of intervals in the CDF, also referred herein as CDF bins, may include a range of consecutive possible values of the series of elements or values. Both the CDF and the PDF may cover the entire range of possible values of the series of elements or values.

In some embodiments, the CDF and PDF may be generated concurrently. For example, sorter building block 242 may traverse the input series of values and fill in the PDF and CDF at the same time. Specifically, sorter building block 242 may organize the series of values in the PDF by finding or counting, for each value of the series of values, a number of occurrences of that value in the input series of values. Concurrently, sorter building block 242 may generate the CDF as disclosed herein. Once the CDF and PDF are ready, sorter building block 242 may use the CDF for a course search. e.g., to find a starting point for a finer search. Sorter building block 242 may use the PDF for the finer search (e.g., by building a second finer CDF), starting from the found starting point as disclosed herein.

OS-CFAR detector 122 may calculate an adaptive threshold for a CUT based on a K^{th} order element or K^{th} order statistic in the reference window surrounding the CUT. For example, adaptive threshold may be the median of the reference window, or the median multiplied by (or added to) a margin factor. Comparator 250 may obtain the adaptive threshold and the reference window and may determine whether an object is detected or not, e.g., by comparing the CUT to the adaptive threshold. For example, comparator 250 may determine that an object is detected if the CUT signal exceeds (e.g., is greater than) the threshold, and that an object is not detected otherwise.

According to embodiments of the invention, sort and select block 240 and sorter building block 242 may be implemented in software, in hardware or a combination of software and hardware, e.g., as part of processor 1410. It should be readily understood that while sorter building block 242 is presented as a building block of sort and select block 240 and as part of OS-CFAR detector 122, it may be implemented as a standalone block and used for any application that required finding the K^{th} largest or smallest element in a series of values.

Embodiments of the invention may be demonstrated using the following example series:
example_in[n]=[49 166 20 104 25 13 0 58 95 30 3 23 8 38 3 50]
   The trivial solution for finding, for example, the 8^{th} smallest element, or the 9th largest element, in example_in[n] would be to sort example_in[n] in ascending order and take the 8^{th} element or to sort example_in[n] in descending order and take the 9^{th} element (25 in this example):
sorted_in[n]=[0 3 3 8 13 20 23 25 30 38 49 50 58 95 104 166]

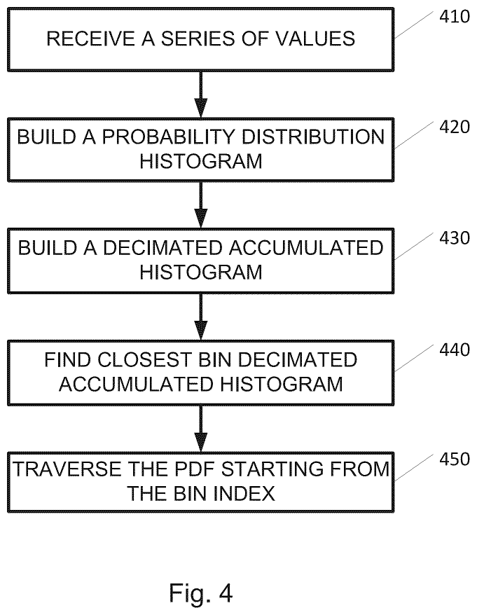

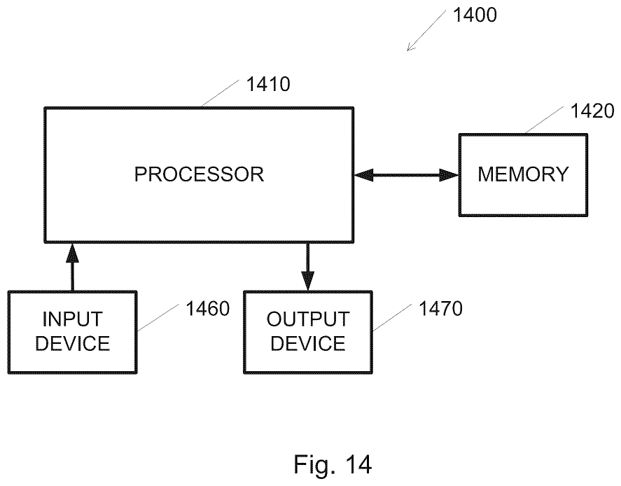

Reference is made to FIG. 4, which is a high-level flowchart illustrating a first method for finding the K^{th} element in a series of values, according to embodiments of the invention. An embodiment of the method for finding the K^{th} element in a series of values may be performed, for example, by OS-CFAR detector 122 shown in FIG. 1, by processor 1410 shown in FIG. 14, or by any other hardware, software, or combination thereof. For example, embodiments of the method for finding the K^{th} element in a series of values may be implemented by a sorter building block. e.g., sorter building block 242.

Embodiments of a method for finding the K^{th} element in a series of values may be used for finding the K^{th} largest or K^{th} smallest element. For clarity, the steps of an example embodiment will be first explained as used for finding the K^{th} smallest element, and then for finding the K^{th} largest element.

In operation 410, a sorter building block may receive or obtain a series of elements also referred to as values, e.g., numbers in any applicable format. Each element or value in the series of elements or values may be one of a series of possible values supported by the application. For example, in some applications, the elements, values or numbers may be obtained as 8-bit unsigned integer format, and there may be 256 possible values. e.g., integer numbers ranging from 0 to 255. Other number formats and other possible values may be used, e.g., number formats such as other lengths of integer formats, floating point number of any format, natural numbers, real numbers, rational numbers, etc., may be used. In some embodiments, the series of elements or values may include reference cells 230 of an OS-CFAR window.

In operation 420, the sorter building block may organize the series of values in a histogram referred to herein as a PDF. The PDF may include a plurality of bins, each bin associated with one of the possible values, and sorter building block may organize the series of values in the PDF by counting or finding a number of occurrences of each value of the series of values and placing the number of occurrences in the associated bin:

$$PDF [ i ] = count ( in [ n ] == i ) \qquad ( Equation 1 )$$

Where i is a possible value.

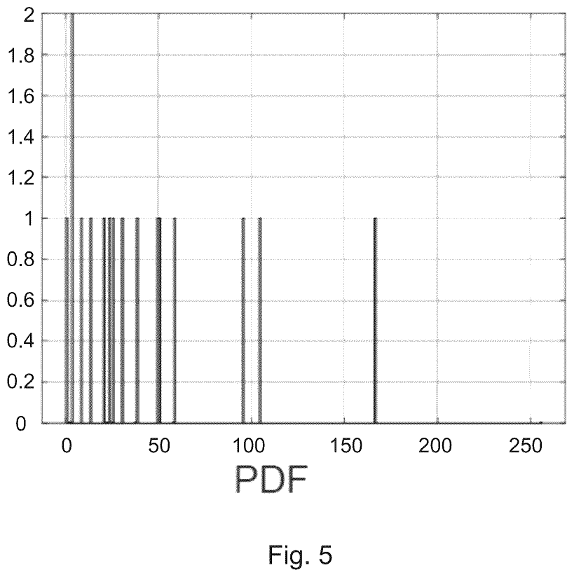

For example, for an 8-bit integer format, there may be 256 possible values, and the PDF may indicate how many elements in the input series of values equal each possible value. Table 1 presents a partial PDF, with values 0-35 and the number of occurrences (referred to as the PDF count) of each value in example_in[n]. The full PDF is presented in FIG. 5.

TABLE 1
Partial PDF for values 0-35 in example_in[n].

| PDF bin | 0 | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| PDF count | 1 | 0 | 0 | 2 | 0 | 0 | 0 | 0 | 1 | 0 | 0 | 0 | 0 | 1 | 0 | 0 | 0 | 0 | 0 |

| PDF bin | 19 | 20 | 21 | 22 | 23 | 24 | 25 | 26 | 27 | 28 | 29 | 30 | 31 | 32 | 33 | 34 | 35 |
|---|---|---|---|---|---|---|---|---|---|---|---|---|---|---|---|---|---|
| PDF value | 0 | 1 | 0 | 0 | 1 | 0 | 1 | 0 | 0 | 0 | 0 | 1 | 0 | 0 | 0 | 0 | 0 |

In operation 430, the sorter building block may organize the series of values in an accumulated histogram referred to herein as a CDF. According to embodiments of the invention, the CDF may include adjacent bins of ranges of values (referred to as CDF bins), where a maximal value included in a CDF bin is referred to as a bin index. Sorter building block may generate the CDF by counting, for each CDF bin, an accumulated number of occurrences of values of the series of values, up to the bin index of the CDF bin, e.g., values that are smaller than or equal to the bin index. The accumulated number of occurrences may be referred to herein as the CDF bin count.

According to some embodiments of the invention, the bins of the CDF are equally spaced. According to some embodiments of the invention, the bins of the CDF are spaced based on a-priory knowledge of statistics or data distribution of previous series of values. As known, the calculation in OS-CFAR are typically performed in a sliding-window manner, where the detector slides from one CUT to another and there might be an overlap of values in the reference window, so the statistics could have similar characteristics and therefore it may be beneficial to use statistics or data distribution of previous reference windows. For example, if the series of values includes values of a window of an OS-CFAR detector, the bins may be spaced based on the K^{th} largest element found in previous windows that were analyzed, and/or based on a distribution of the series of values of previous OS-CFAR windows. For example, bins of the CDF may be denser around the K^{th} largest element that was found in a previous window (the previous K^{th} largest element), e.g., values of the bin indexes may be closer to each other, comparing to bins that are further away from the previous K^{th} largest element. For example, bin indexes may be spaced in gaps of 2, 4, 8 or 16 around the previous K^{th} largest element, and have larger gaps further from the previous K^{th} largest element. According to embodiments of the invention, the gaps may be selected based on knowledge of the distribution of values in previous windows. In one example, for a possible range of values, a first half of the range may include more bins comparing to the second half of the range, where the previous K^{th} largest element is located in the center of the first half.

For example, for 8-bit integer format, the bin indexes for equally spaced bins may be [15 31 47 63 79 95 111 127 143 159 175 191 207 223 239]. In another example, where it is known that the previous K^{th} largest element was 80, the bin indexes may be denser around the value 80 and less dense elsewhere, for example [26 53 74 76 78 80 82 84 86 113 140 167 194 221 248].

Table 2 presents a CDF generated for example_in[n]. As can be seen, the number of values in example_in[n] that are below the first bin index 15. e.g., the CDF count of the first bin, is 5, the accumulated number of values that are below the second bin index 31. e.g., the CDF count of the second bin, is 9, etc. The accumulated number of values that are below the seventh bin index 111. e.g., the CDF count of the seventh bin, is 15. As there are no values of example_in[n] in the next three bins, the accumulated number of values that are below the eighth, nineth and tenth bins is also 15. A dummy bin #0 is logically added with a bin index and bin value of zero.

TABLE 2
CDF of example_in[n].

| | CDF bin number | | | | | | | | |
|---|---|---|---|---|---|---|---|---|---|
| | 0 | 1 | 2 | 3 | 4 | 5 | 6 | 7 | 8 |
| CDF bin | 0 | 15 | 31 | 47 | 63 | 79 | 95 | 111 | 127 |
| index | | | | | | | | | |
| CDF count | 0 | 15 | 9 | 10 | 13 | 13 | 14 | 15 | 15 |

| | CDF bin number | | | | | | |
|---|---|---|---|---|---|---|---|
| | 9 | 10 | 11 | 12 | 13 | 14 | 15 |
| CDF bin | 143 | 159 | 175 | 191 | 207 | 223 | 239 |
| index | | | | | | | |
| CDF count | 15 | 15 | 16 | 16 | 16 | 16 | 16 |

According to embodiments of the invention, operations 420 and 430 may be performed concurrently. e.g., the PDF and CDF may be built in parallel.

In operation 440, the sorter building block may find in the CDF a CDF bin with the largest associated accumulated number of occurrences, e.g., CDF count, that is smaller than K. Thus, operation 440 may be a coarse search of the K^{th} smallest element.

For example, when searching for the 8^{th} smallest element in example_in[n], the sorter building block may find bin 1, for which the bin index is 5, since the bin index of the next bin is larger than 8. In another example, when searching for the 15^{th} smallest element in example_in[n], the sorter building block may find bin 6, for which the bin index is 14, since the bin index of the next bin is equal (and not smaller) than 15.

In operation 450, the sorter building block may perform a fine search for the K^{th} smallest element by searching the PDF starting from the found bin index, e.g., staring from the bin index and going up. For example, the sorter building block may traverse the PDF to find the K^{th} smallest element starting from the bin following the bin index. Thus, the accumulated number of elements of the series of values up to the bin index, e.g., the bin count, is known and is smaller than K, and thus the bin index is the starting point of the search. Thus, the sorter building block may check each bin of the PDF stating from the bin following the bin index sequentially, and add, to the bin value of the found CDF bin, the number of elements of the series of values that are located in each PDF bin, until reaching K and thus finding the K^{th} largest element. For example, the following equation may be used:

$$CDF [ j ] = CDF [ {j}_{decimated} ] + {{\sum }^{j}}_{n = {j}_{decimated} + 1} PDF [ n ]$$

Where j_{decimated} is the found bin index (e.g., the bin index of the found bin).

This process may be equivalent to building a full resolution CDF starting from the found bin index (or the value right after the bin index) using the PDF data, until the exact K^{th} element is found. For example, the full resolution CDF may include a bin for each PDF bin, e.g., for each possible value in the series of values staring from the found bin index and up to the K^{th} element.

According to embodiments of the invention, the K^{th} smallest element value found in operation 450 may be later used for further processing, depending on the application. In one example, OS-CFAR detector 122 may use the found value to determine if there is a target in an OS-CFAR window.

For example, when searching for the 8^{th} smallest element in example_in[n], the sorter building block may, after finding bin 1 of the CDF in operation 440 (the coarse search), perform a fine search in the PDF, starting after the bin index of bin 1 (or at the first bin value of bin 2 of the CDF), which is PDF bin value 16. Since there are no values of example_in[n] in PDF bin 16 (see Table 1), the sorter building block may continue to bin 17 of the PDF, which is also empty. Similarly, the sorter building block may continue to bins 18 and 19 of the PDF, which are empty as well. Bin 20 includes a single element, which is the 6^{th} largest element in example_in[n] (the CDF value of CDF bin 1 is five, meaning that five elements of example_in[n] are included in bin 1 of the CDF). The sorter building block may continue to traverse the PDF and find the 7^{th} smallest element in example_in[n] in PDF bin 23, and the 8^{th} smallest element in example_in[n] in PDF bin 25. Thus, the 8^{h} smallest element in example_in[n] is 25.

As noted, the fine search may include reconstructing a full resolution CDF starting from after the bin index of bin 1 (or at the first bin value of bin 2 of the CDF). Using decimated CDF it is known that CDF[15]=5 and CDF[31]=9. Calculating the first value in the full resolution CDF, which in this example is CDF[16] is done by CDF[16]=CDF[15]+PDF[16].similarly, CDF[17]=CDF[16]+PDF[17] and so on. This calculation may be repeated until CDF[X]=8, where the desired value of X is found. In this example CDF[25]=8, and therefore the 8^{th} smallest element in example_in[n] is 25.

For finding the K^{th} largest element, operations 410 and 420 may be performed as described above. In operation 430, the bin index may be selected as the minimal value included in a CDF bin, and the sorter building block may organize the series of values in the CDF by counting, for each CDF bin, an accumulated number of occurrences of values of the series of values, down to the bin index, e.g., values that are larger than or equal to the bin index. In operation 440, the sorter building block may find in the CDF a CDF bin with the smallest associated accumulated number of occurrences that is larger than K. Thus, operation 440 may be a coarse search of the K^{th} largest element. In operation 450, the sorter building block may perform a fine search in the PDF, based on results of the coarse search (performed in operation 440), e.g., the sorter building block may search the PDF for the K^{th} largest element starting from the found bin index (e.g., the bin index of the found bin) and going down.

According to some embodiments of the invention, when using embodiments of the method for finding the K^{th} element in a series of values by OS-CFAR detector 122, further efficiency may be achieved in operations 420 and 430. For example, instead of populating or building a new PDF and CDF for each new window, a former or previous PDF and CDF may be updated by removing the elements that were part of the previous window and are no longer part of the new or current window, and adding the elements that were not included in the previous window and are part of the new or current window. This further efficiency may be achieved for any sliding window application.

Embodiments of the method for finding the K^{th} element in a series of values may be augmented for other data types. For example, one or more implementations of the sorter building block may be used as a building blook for more complex sorters supporting longer integer formats, floating point numbers, etc. For example, two sorter building blocks for 8-bit integer format, may be used for finding the K^{th} element in 16-bit integer format, four sorter building blocks for 8-bit integer format may be used for finding the K^{th} element in 32-bit integer format, etc. In a more general form, unsigned integer formats with a*b bits, where a and b are integer numbers larger than 1, may be divided into a subblocks (e.g., groups of adjacent bits), each with b bits, a sorter building blocks, each for b bits, may be used to sort the a*b bits unsigned integer formats. According to some embodiments, at least two sorter building blocks of b-bit integer format may be used for finding the K^{th} element in floating point numbers, one or more for the mantissa and one or more for the exponent (also referred to as exp). Other methods may be used for finding the K^{th} element in various computer number formats and representations in a required accuracy. According to embodiments of the invention, one or more implementations of the sorter building block may be used as a building blooks with floating point number types or integer formats in any bit length, to provide an estimation of the K^{th} element or the precise K^{th} element.

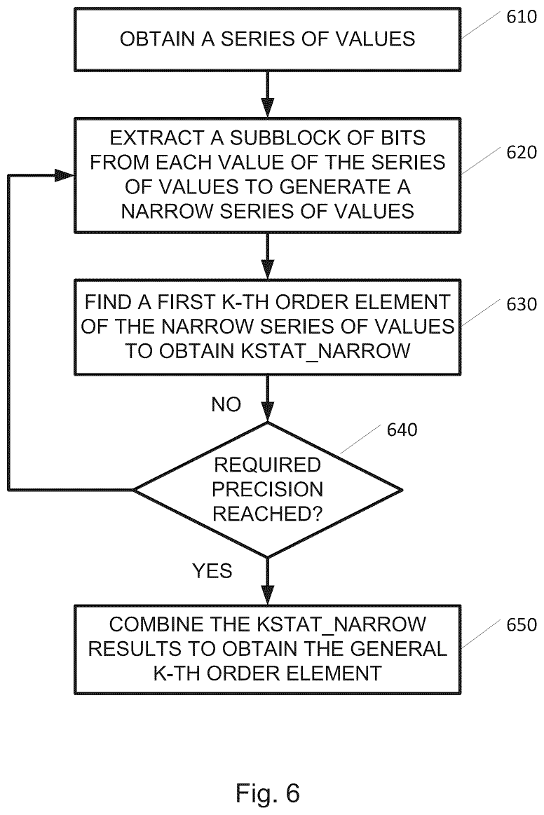

Reference is made to FIG. 6, which is a high-level flowchart illustrating a method for finding the K^{th} order element in a series of values, according to embodiments of the invention. An embodiment of the method for finding the K^{th} order element in a series of values may be performed, for example, by OS-CFAR detector 122 shown in FIG. 1, by processor 1410 shown in FIG. 14, or by any other hardware, software, or combination thereof. For example, embodiments of the method for finding the K^{th} element in a series of values may be implemented by a sort and select block, e.g., sort and select block 240.

In operation 610, a sort and select block may receive or obtain a series of elements or values. e.g., numbers in any applicable format. Each element or value in the series of elements or values may be one of a series of possible values supported by the application. For example, number formats such as any length of integer formats (e.g., any bit-length integer formats), floating point numbers of any format, natural numbers, real numbers, rational numbers, etc. In some embodiments, the series of elements or values may include reference cells 230 of an OS-CFAR window.

In operation 620, the sort and select block may extract or select a subblock of bits associated with each value of the series of values to generate a narrow series of values. For example, the sort and select block may select the most significant bits (MSB) of integer format elements, the exponent of floating point numbers, or may perform an operation on each of the values in the series of values and take part or all of the result. For example, for a series of unsigned integer formats, the sort and select block may perform a log₂ operation and extract an integer (number) part of the result.

In operation 630, the sort and select block may find a K^{th} order element of the narrow series of values. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In some embodiments, operation 630 may provide an approximation of the K^{th} order element, and the precision of this estimation may be evaluated experimentally or theoretically, e.g., offline. As indicated in operation 640, if the required precision is not reached (e.g., not above a threshold), then embodiments of the method may return to operation 620 to extract or select a second subblock of bits associated with each value of the series of values to generate a second narrow series of values, and to operation 630 to find a second K^{th} (e.g., an adjusted K^{th}) order element of the second narrow series of values. These iterations may be repeated until a required precision is reached. As indicated in operation 640, if the required precision is reached (e.g., precision is above a threshold) then embodiments of the method may continue to operation 650. In operation 650, the sort and select block may combine the one or more K^{th} order elements to obtain a general K^{th} order element or the entire series of values. Embodiments of the method for finding the K^{th} order element in a series of values will be demonstrated herein for various data types and precision levels.

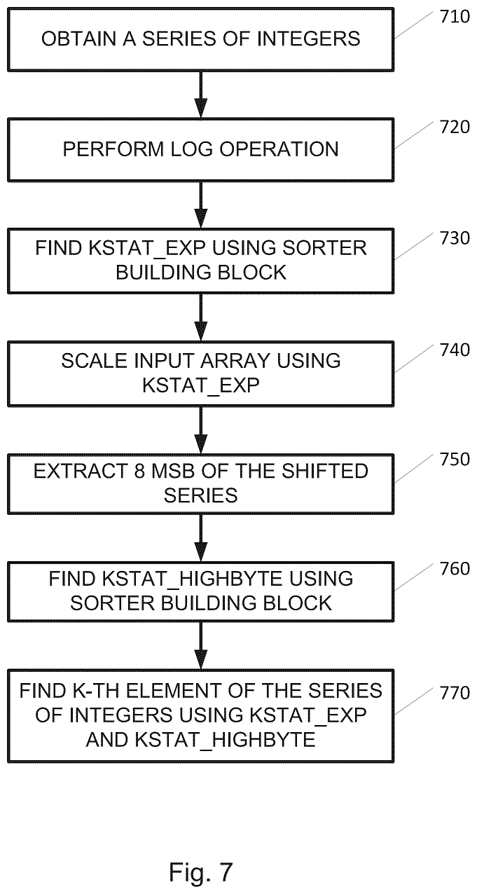

Reference is made to FIG. 7, which is a high-level flowchart illustrating a method for estimating the K^{th} order element in a series of values provided in unsigned integer format, according to embodiments of the invention. An embodiment of the method for estimating the K^{th} order element in a series of values provided in integer format may be performed, for example, by OS-CFAR detector 122 shown in FIG. 1, by processor 1410 shown in FIG. 14, or by any other hardware, software, or combination thereof. For example, embodiments of the method for estimating the K^{th} element in a series of values provided in integer format may be implemented by a sort and select block, e.g., sort and select block 240.

In operation 710, a sort and select block may receive or obtain a series of elements or values in unsigned integer format, e.g., each element or value in the series of elements or values may be one of a series of possible values supported by the unsigned integer format. For example, for 16-bit unsigned integer format, the possible values are integer numbers between 0 and 65,535. In some embodiments, the series of elements or values may include reference cells 230 of an OS-CFAR window.

In operation 720, the sort and select block may extract a subblock of bits associated with each value of the series of values to generate a first narrow series of values by performing a log₂ operation on the series of the unsigned integers and extracting an integer (number) part of the result. In operation 730, the sort and select block may find a K^{th} order element of the narrow series of values, referred to herein as KStat_exp. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In operation 740, the sort and select block may scale the series of unsigned integers by shifting left with saturation, each of the unsigned integers by the number of bits in the narrow series of values (e.g., the number of bits in KStat_exp) to obtain a shifted series (e.g., the series of elements or values after the shifting operation). Shifting left with saturation may include moving each digit in the binary representation by one step to the left such that the most-significant bit is lost, and a ‘0’ bit is inserted as the least significant bit, and taking the maximum value between the shifted and the original data element.

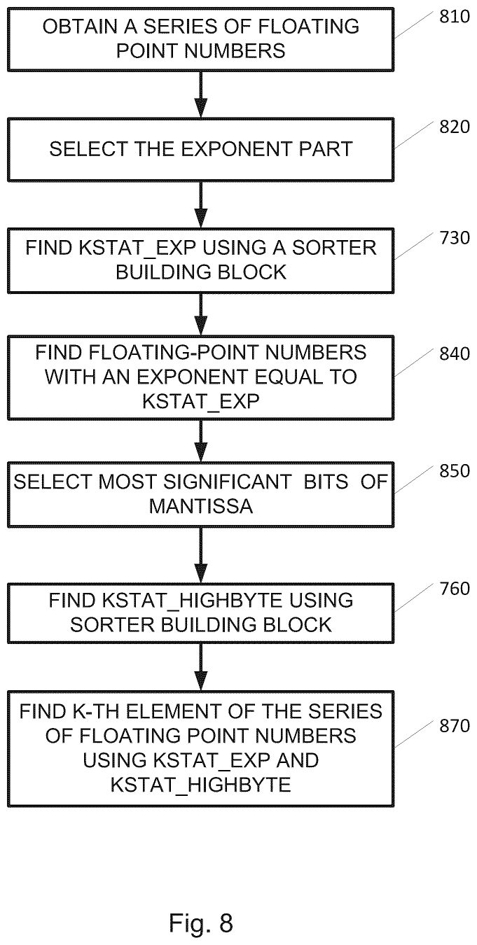

In operation 750, the sort and select block may extract some (b), e.g., four, eight, sixteen, etc. most significant bits (MSBs) of the shifted series. In operation 760, the sort and select block may find a second K^{th} largest element for the MSBs of the shifted series, referred to herein as KStat_HighBits. Again, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In operation 770, the sort and select block may combine the KStat_exp and KStat_HighBits to obtain the general K^{th} order element, for example using:

$${general\_K}^{th} \_order \_element = KStat\_HighBits * {2}^{KStat \_ exp + exp \_ bias}$$

Where exp_bias is a function of the number of input bits, and the number of bits extracted bits (b). For example, in this case exp_bias equals minus b, exp_bias=−b, where b is the number of bits in a subblock or subblock size. If for example, b=8 bits then exp_bias=−b=−8. Reference is made to FIG. 8, which is a high-level flowchart illustrating a method for estimating the K^{th} order element in a series of values provided in floating point format, according to embodiments of the invention. An embodiment of the method for finding the K^{th} order element in a series of values provided in floating point format may be performed, for example, by OS-CFAR detector 122 shown in FIG. 1, by processor 1410 shown in FIG. 14, or by any other hardware, software, or combination thereof. For example, embodiments of the method for finding the K^{th} element in a series of values provided in floating point format may be implemented by a sort and select block, e.g., sort and select block 240.

In operation 810, a sort and select block may receive or obtain a series of elements or values in floating point format. e.g. a series of floating point numbers. In some embodiments, the series of elements or values may include reference cells 230 of an OS-CFAR window.

In operation 820, the sort and select block may extract a subblock of bits associated with each value of the series of values to generate a first narrow series of values by extracting the exponent part of each of the floating-point numbers of the series of floating-point numbers. In operation 730, the sort and select block may find a K^{th} order element of the narrow series of values, referred to herein as KStat_exp. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used.

In operation 840, the sort and select block may find in the series of floating-point numbers floating-point numbers with an exponent equal to KStat_exp. In operation 850, the sort and select block may and extract a set of MSBs (e.g., four, eight, sixteen, etc.) of a mantissa of the floating-point numbers with exponent of KStat_exp to generate a series of MSBs.

In operation 760, the sort and select block may find a second K^{th} largest element for the MSBs of the series of MSBs, referred to herein as KStat_HighBits. Again, the sort and select block may find the K^{th} order element using embodiments of the method for finding the Kil element in a series of values as disclosed herein with reference to FIG. 4. However, this is not limiting and any other sorter or method for finding the K^{th} order element may be used. In operation 770, the sort and select block may combine the KStat_exp and KStat_HighBits to obtain the general K^{th} order element KstatApprox, for example, using:

$$KstatApprox = KStat\_HighBits * {2}^{KStat \_ exp + bias}$$

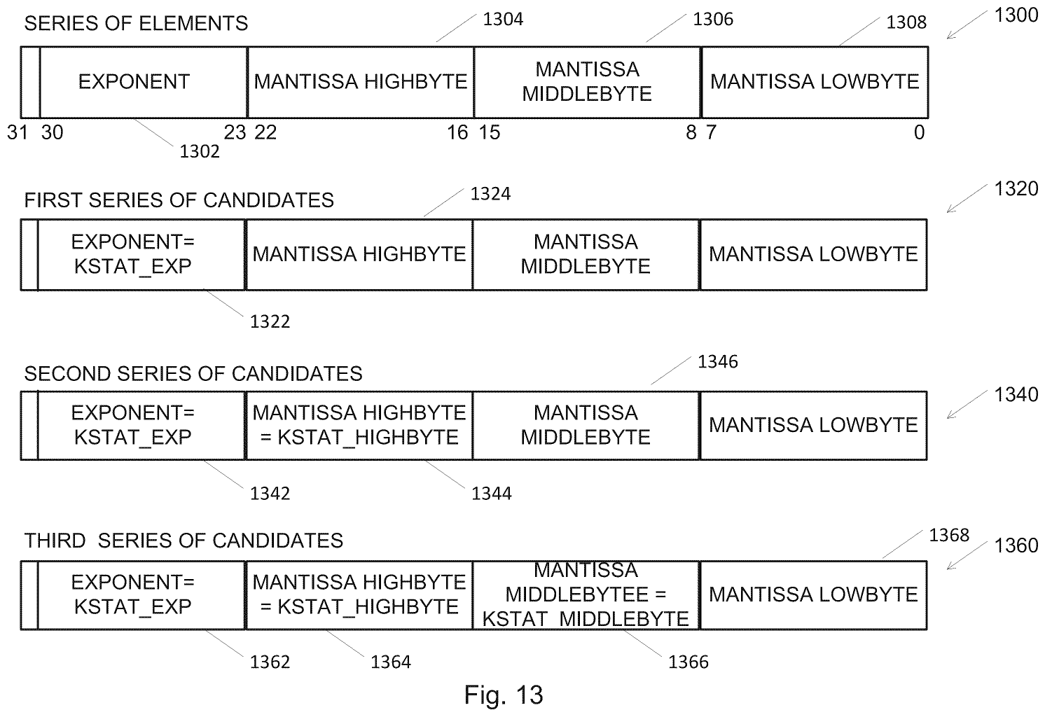

According to some embodiments, embodiments of the method for estimating the K^{th} order element in a series of values provided in integer format as described with reference to FIG. 7 and embodiments of the method for estimating the K^{th} order element in a series of values provided in floating point format as described with reference to FIG. 8 may provide high accuracy results with about half the computational complexity comparing to the full precision algorithm as described herein with reference to FIG. 13. For example, when using a sorter block for 8-bits, the 8 MSBs provided by embodiments of the method described in FIGS. 7 and 8 are the true MSBs. Embodiments of the methods for estimating the K^{th} largest element were tested experimentally over large dataset of input series, the results have shown that the signal to quantization noise (e.g., the noise added by the approximation relatively to the true value) is approximately −50 dB:

$$QSNR = 20 {log}_{10} ( \frac{abs ( KstatApprox - KstatIdeal}{KstatIdeal} ) = \sim - 50 dB$$

Where Kstatldeal is the true K^{th} order element and KstatApprox is the approximated K^{th} order element.

Table 3 provides a numerical example of a series of 16 elements provided in 32-bit unsigned integer format. The first column provides the original series, the second column provides the sorted series, in which the true 8^{h} element is highlighted (587089), and the third column provides the result of performing a log₂ on the elements of the input series, here KStat_exp is highlighted (20). The fourth column provides the input series after shifting left by 20 bits with saturation operation. The fifth column provides the MSBs, in which KStat_HighBits is highlighted (143). The approximated K^{th} largest element may be calculated by:

$$statApprox = KStat\_HighBits * {2}^{KStat \_ exp - 8} = 143 * {2}^{20 - 8} = 585728$$

The accuracy of the approximated K^{th} largest element comparing with the true K^{th} largest element may be calculated by:

$$QSNR = 20 {log}_{10} ( \frac{abs ( KstatApprox - KstatIdeal}{KstatIdeal} ) = 20 {log}_{10} ( \frac{abs ( 585728 - 587089}{587089} ) = - 52.7 dB$$

TABLE 3
A numerical example.

| | | | Input series | |
|---|---|---|---|---|
| | | Log₂ | shifted left by | |
| Input | Sorted | (input | 20 bits with | |
| series | series | series) | saturation | MSB |
| 1220506 | 23680 | 21 | 4.29E+09 | 255 |
| 1278469 | 96236 | 21 | 4.29E+09 | 255 |
| 307064 | 118540 | 19 | 1.26E+09 | 74 |
| 329700 | 290982 | 19 | 1.35E+09 | 80 |
| 587089 | 307064 | 20 | 1.35E+09 | 143 |
| 1134230 | 317549 | 21 | 4.29E+09 | 255 |
| 2033438 | 329700 | 21 | 4.29E+09 | 255 |
| 96236 | 587089 | 17 | 3.94E+08 | 23 |
| 23680 | 1134230 | 15 | 96993280 | 5 |
| 1805409 | 1220506 | 21 | 4.29E+09 | 255 |
| 1945761 | 1278469 | 21 | 4.29E+09 | 255 |
| 290982 | 1691083 | 19 | 1.19E+09 | 71 |
| 2371028 | 1805409 | 22 | 4.29E+09 | 255 |
| 317549 | 1945761 | 19 | 1.3E+09 | 77 |
| 1691083 | 2033438 | 21 | 4.29E+09 | 255 |
| 118540 | 2371028 | 17 | 4.86E+08 | 28 |

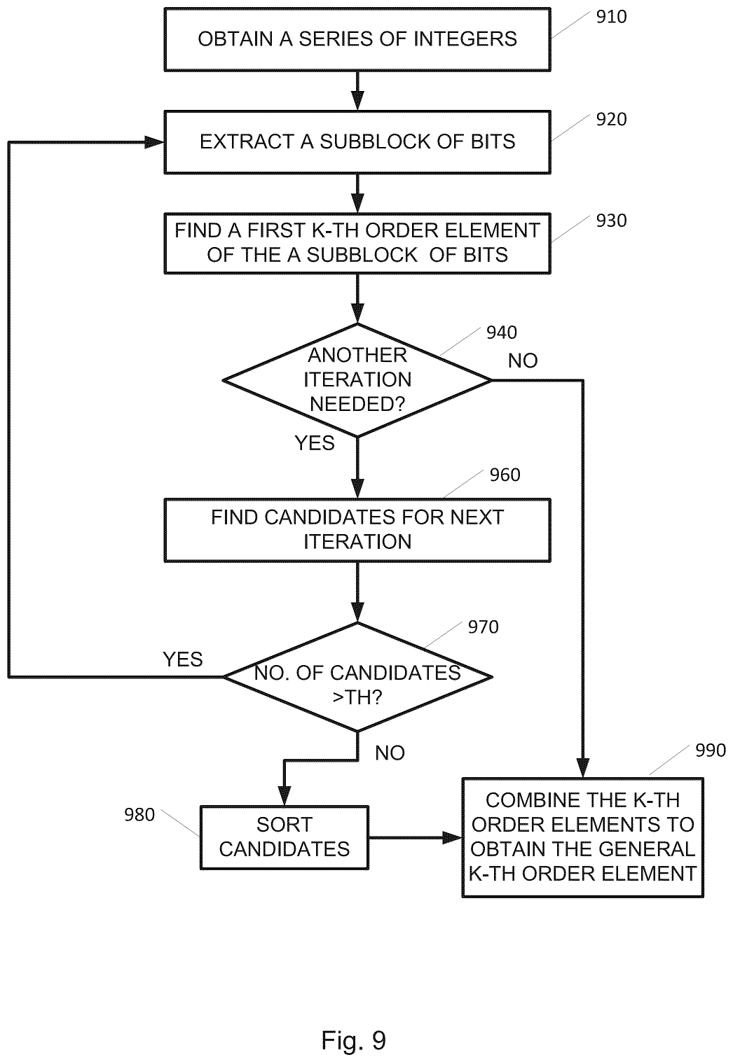

Reference is made to FIG. 9, which is a high-level flowchart illustrating a method for finding the K^{th} order element in a series of values provided in unsigned integer format, according to embodiments of the invention. An embodiment of the method for finding the K^{th} order element in a series of values provided in integer format may be performed, for example, by OS-CFAR detector 122 shown in FIG. 1, by processor 1410 shown in FIG. 14, or by any other hardware, software, or combination thereof. For example, embodiments of the method for finding the K^{th} element in a series of values provided in integer format may be implemented by a sort and select block, e.g., sort and select block 240.

In operation 910, a sort and select block may receive or obtain a series of elements or values in unsigned integer format, e.g., each element or value in the series of elements or values may be one of a series of possible values supported by the unsigned integer format. The length, in bits of each of the elements may a*b bits, where a is a number of subblocks and b is a number of bits in each subblock, and a and b are integer numbers larger than 1. For example, b may equal 8 (byte) and a may equal 2 for 16-bit unsigned integer, 4 for 32-bit unsigned integer, etc. A first column in Table 4 includes an example of a series of elements or values in unsigned integer format were a=b=2, e.g., each elements includes two subblocks of 2 bits.

In operation 920, the sort and select block may select a subblock of b bits from each value of the series of values to generate a narrow series of values. For example, in a first iteration, the sort and select block may select b MSBs (e.g., if b=8, the sort and select block may select the eight MSBs) of the integer format elements to obtain a series of MSBs. In the example presented in table 4, two MSBs may be selected. The series of selected MSBs is presented in the third column.

In operation 930, the sort and select block may find a K^{th} order element of the narrow series of values. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In the first iteration, the sort and select block may find a K^{th} order element of the series of MSBs, referred to herein as KStat_MSB. In the example presented in Table 4, the sort and select block has to find the fifth largest element (K=5). The fifth largest element (10) is highlighted in the third column.

In block 940, the sort and select block may determine whether another iteration is required. Another iteration may not be required if a required precision was reached and/or if there are no more bits to analyze. If a required precision was not reached and there are more bits to analyze, then embodiments of the method may continue to operation 960. In operation 960, the sort and select block may find candidates for a next iteration in the series of unsigned integers. For example, the sort and select block may find in the series of unsigned integers unsigned integers with MSBs that equal KStat_MSB to generate a series of candidates. In operation 970, the number of candidates may be evaluated. If the number is small (e.g., smaller than a threshold number of candidates), embodiments of the method may continue to operation 980 to sort the candidates. After sorting the candidates, embodiments of the method may continue to operation 990, to combine the KStat_MSB with the KStat_subblocks and find the K^{th} element of the entire series of unsigned integers 1100. If, however, the number of candidates is large (e.g., equals or above the threshold number of candidates), embodiments of the invention may return to operation 920 to extract, from the series of candidates, another subblock of bits. e.g., the next subblock of b bits. e.g., the subblock following the previous extracted subblock. For example, if a size of a subblock is byte, the MSB byte may be analyzed in a first iteration, the following byte may be analyzed in a second iteration, and the LSB byte may be analyzed in a last iteration. In subsequent iterations, e.g., all iterations except the first iteration, an adjusted K^{th} element may be found among the selected candidates in operation 930. The adjusted K^{th} element may be referred to herein as KStat_subblock. The value of the adjusted K may be determined by subtracting the number of elements having selected bits that are smaller than the value of K^{th} or adjusted K^{th} order element of the previous iteration from K or the adjusted K of the previous iteration.

If another iteration is not required, (operation 940) then embodiments of the method may continue to operation 990 to combine the KStat_MSB with the KStat_subblocks to generate the general K^{th} largest element of the series of unsigned integers.

In the example presented in table 4, the candidates found after the first iteration include elements 1001, 1000 and 1000. The second subblock of bits include the two LSBs and is presented in the fourth column. The sorted LSBs are presented in the fifth column. The value of the adjusted K for the second iteration is determined by subtracting the number of values having selected bits that are smaller than the K^{th} order element of the first irritation, which is four, from K which in this example is five. Thus, the value of the adjusted K for the second iteration is 5−4=1.

TABLE 4
A numerical example.

| Input | Sorted | | LSBs of | Sorted LSBs |
|---|---|---|---|---|
| series | series | MSB | Candidates | of candidates |
| 1001 | 0101 | 01 | | |
| 0110 | 0110 | 01 | | |
| 0111 | 0111 | 01 | | |
| 0101 | 0111 | 01 | | |
| 0111 | 1000 | 10 | 01 | 00 |
| 1110 | 1000 | 10 | 00 | 00 |
| 1000 | 1001 | 10 | 00 | 01 |
| 1000 | 1110 | 11 | | |

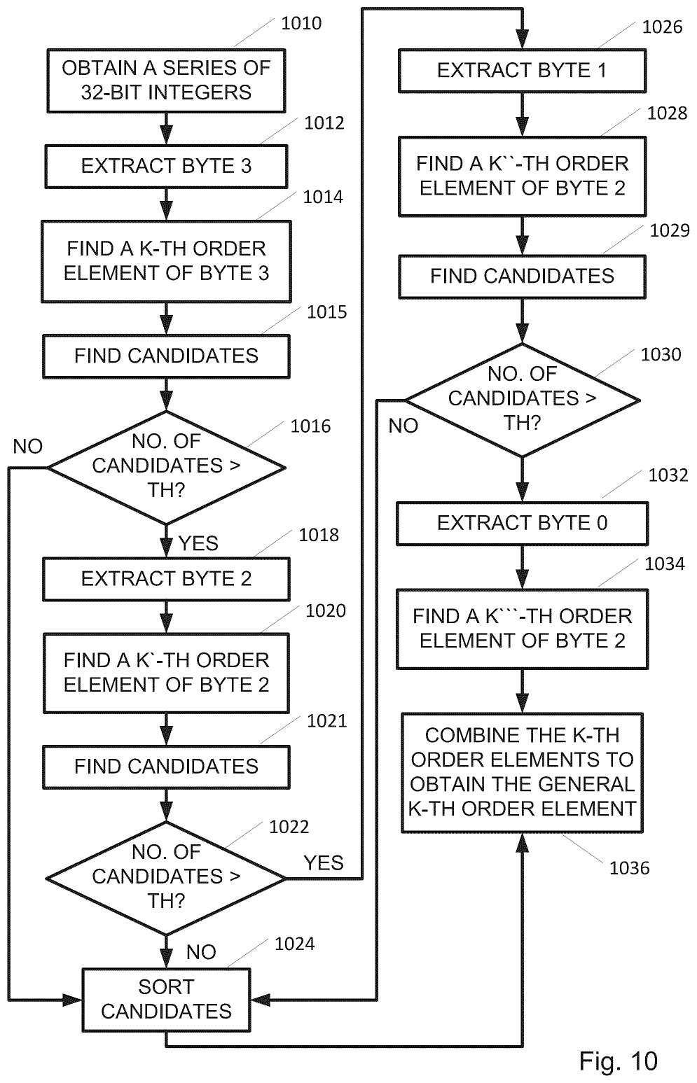

Reference is made to FIG. 10, which is a high-level flowchart illustrating a method for finding the K^{th} order element in a series of 32-bit unsigned integers, according to embodiments of the invention. An embodiment of the method for finding the K^{th} order element in a series of 32-bit unsigned integers may be seen as an example embodiment of the method for finding the K^{th} order element in a series of values provided in integer format as implemented for 32-bit unsigned integers. An embodiment of the method for finding the K^{th} order element in a series of 32-bit unsigned integers may be performed, for example, by OS-CFAR detector 122 shown in FIG. 1, by processor 1410 shown in FIG. 14, or by any other hardware, software, or combination thereof. For example, embodiments of the method for finding the K^{th} order element in a series of 32-bit unsigned integers may be implemented by a sort and select block. e.g., sort and select block 240.

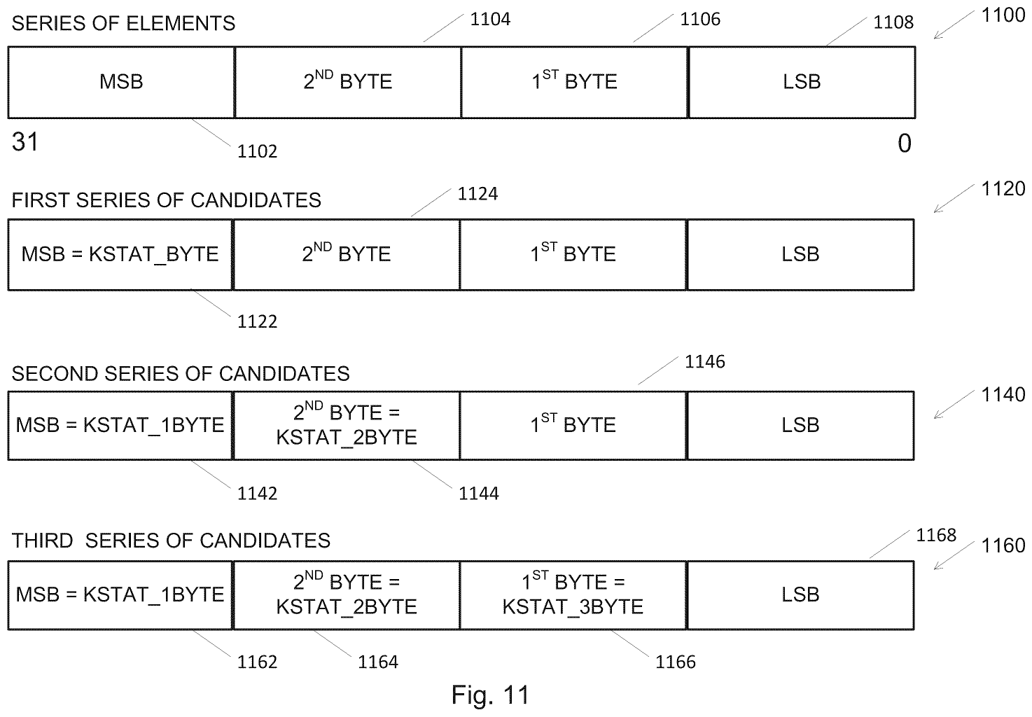

In operation 1010, a sort and select block may receive or obtain a series of elements or values in 32-bit unsigned integer format, e.g., each element or value in the series of elements or values may be one of a series of possible values supported by the 32-bit unsigned integer format. In this example, the size of each subblock is a byte, b=8, and the number of subblocks is four, a=4. An exemplary series of 32-bit unsigned integer format elements 1100 (referred to herein as a 32-bit unsigned integer series) is provided in FIG. 11. An element of the 32-bit unsigned integer series 1100 may include 32 bits, arranged in four bytes. MSB byte 1102, including bits 31-24, 2^{nd} byte 1104, including bits 23-16, 1^{st} byte 1106, including bits 15-8, and LSB byte 1108, including bits 7-0.

In operation 1012, the sort and select block may select the MSB byte 1102 (the third byte) from each value of the series of values to generate a series of MSBs (the third byte series). In operation 1014, the sort and select block may find a K^{th} order element of series of MSBs, referred to herein as KStat_MSB. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In operation 1015, the sort and select block may find candidates for a second iteration in the series of unsigned integers. For example, the sort and select block may find in the series of unsigned integers unsigned integers with MSBs that equal KStat_MSB to generate a first series of candidates. Thus, all the elements in the first series of candidates may an include MSB byte that equals KStat_MSB. Other elements in the series of elements (elements that include an MSB byte that does not equal KStat_MSB) may not be searched in further iterations. An exemplary element 1120 of the first series of candidates is presented in FIG. 11.

In operation 1016, the number of candidates in the first series of candidates may be evaluated. If the number is small (e.g., smaller than a threshold number of candidates), embodiments of the method may continue to operation 1024 to sort the first series of candidates. After sorting the candidates, embodiments of the method may continue to operation 1036, to combine the combine the K, K′, K″ and K′″ (as required) and find the K^{th} element of the entire series of unsigned integers 1100. If, however, the number of candidates is large (e.g., equals or above the threshold number of candidates), embodiments of the invention may continue to operation 1018 to extract, from the first series of candidates 1120, another subblock of bits, e.g., the next byte, e.g., the 2^{nd} byte 1124 to generate a series of 2^{nd} bytes (the second byte series). In operation 1020, an adjusted K^{th} element (also referred to as the K^{th} element or KStat_2 byte) may be found among the series of 2^{nd} bytes. The value of the adjusted K (e.g., K′) may be determined by subtracting the number of elements in the series of elements having MSB byte 1102 that is smaller than KStat_MSB from K:

$${K}^{′} = K - ( number of elements with MSB byte < KStat\_MSB )$$

According to some embodiments, the sort and select block may find the K′^{th} order element in the first series of candidates using embodiments of the method for finding the K^{th} element in a series of values as disclosed herein with reference to FIG. 4. However, this is not limiting and any other sorter or method for finding the K′^{th} order element may be used.

In operation 1021, the sort and select block may find candidates for a third iteration in the first series of candidates. For example, the sort and select block may find in the first series of candidates 32-bit unsigned integers with 2^{nd} byte that equals KStat_2 byte to generate a second series of candidates. Thus, all the elements in the second series of candidates 1140 may include MSB byte that equals KStat_MSB and 2^{nd} byte that equals KStat_2 byte. Other elements in the series of elements (elements that include MSB byte that does not equal KStat_MSB and elements that include an MSB byte that equals KStat_MSB and a 2^{nd} byte that does not equal KStat_2 byte) may not be searched in further iterations. An exemplary element 1140 of the second series of candidates is presented in FIG. 11.

In operation 1022, the number of candidates in the second series of candidates 1140 may be evaluated. If the number is small (e.g., smaller than a threshold number of candidates), embodiments of the method may continue to operation 1024 to sort the second series of candidates and find the K^{th} element of the entire series of unsigned integers 1100. If, however, the number of candidates is large (e.g., equals or above the threshold number of candidates), embodiments of the invention may continue to operation 1026 to extract, from the second series of candidates 1140, another subblock of bits. e.g., the next byte, e.g., the 1^{st} byte 1146 to generate a series of 1^{st} bytes (the first byte series). In operation 1028, an adjusted K^{th} element (also referred to as the K″^{th} element or KStat_1 byte) may be found among the series of 1^{st} bytes. The value of the adjusted K (e.g., K″) may be determined by subtracting the number of elements in the first series of candidates having second byte 1144 that is smaller than KStat_2 byte from K′.

$${K}^{″} = {K}^{′} - ( number of elements in \text{} the \text{} first series of candidtates with 2 nd byte < KStat\_ 2 byte )$$

According to some embodiments, the sort and select block may find the K″^{th} order element in the second series of candidates 1140 using embodiments of the method for finding the K^{th} element in a series of values as disclosed herein with reference to FIG. 4. However, this is not limiting and any other sorter or method for finding the K″^{th} order element may be used.

In operation 1029, the sort and select block may find candidates 1160 for a fourth and last iteration in the second series of candidates 1140. For example, the sort and select block may find in the second series of candidates 1140, 32-bit unsigned integers with Pt byte 1166 that equals KStat_1byte to generate a third series of candidates 1160. Thus, all the elements in the third series of candidates may include MSB byte that equals KStat_MSB, 2^{nd} byte that equals KStat_2 byte and 1^{st} byte that equals KStat_1byte. Other elements in the series of elements may not be searched in the fourth iteration.

In operation 1030, the number of candidates in the third series of candidates 1160 may be evaluated. If the number is small (e.g., smaller than a threshold number of candidates), embodiments of the method may continue to operation 1024 to sort the second series of candidates 1140 and find the K^{th} element of the entire series of unsigned integers 1100. If, however, the number of candidates is large (e.g., equals or above the threshold number of candidates), embodiments of the invention may continue to operation 1032 to extract, from the third series of candidates 1160, another subblock of bits, e.g., the next byte, e.g., the LSB byte 1168 to generate a series of LSB bytes (the LSB byte series). In operation 1034, an adjusted K^{th} element (also referred to as the K′″^{th} element or KStat_LSB) may be found among the series of LSB bytes. The value of the adjusted K (e.g., K′″) may be determined by subtracting the number of elements in the second series of candidates having first byte 1166 that is smaller than KStat_1 byte, from K″.

$${K}^{″} = {K}^{′} - ( number of elements in \text{} the \text{} second series of candidtates with 1 st byte < KStat\_ 1 byte )$$

According to some embodiments, the sort and select block may find the K′″^{th} order element in the third series of candidates using embodiments of the method for finding the Kth element in a series of values as disclosed herein with reference to FIG. 4. However, this is not limiting and any other sorter or method for finding the K′″^{th} order element may be used.

In operation 1036, the sort and select block may combine K, K′, K″ and K′″ to find or obtain the general K^{th} order element. For example, the sort and select block may select the element for which the MSB byte 1102 equals KStat_MSB, 2^{nd} byte 1104 equals KStat_2 byte, 3 byte 1106 equals KStat_2 byte, and LSB byte 1108 equals KStat_LSB.

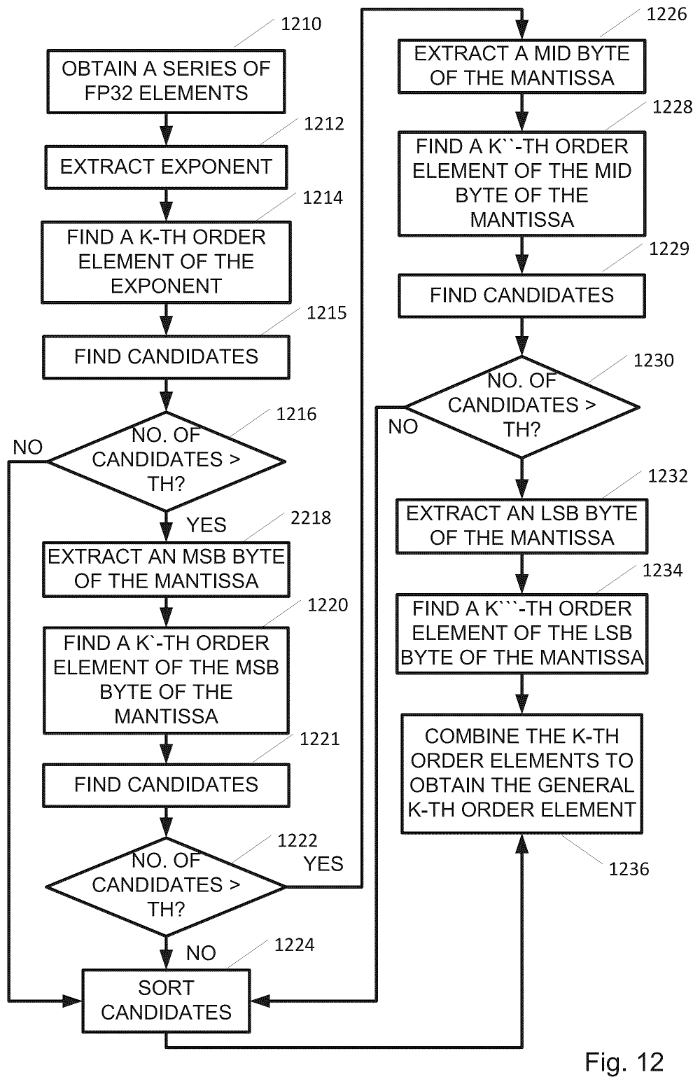

Reference is made to FIG. 12, which is a high-level flowchart illustrating a method for finding the K^{th} order element in a series of floating point numbers, according to embodiments of the invention. An embodiment of the method for finding the K^{th} order element in a series of 32-bit floating point number may be seen as an example of the method for finding the K^{th} order element in a series of values as implemented for floating point numbers. An embodiment of the method for finding the K^{th} order element in a series of floating-point numbers may be performed, for example, by OS-CFAR detector 122 shown in FIG. 1, by processor 1410 shown in FIG. 14, or by any other hardware, software, or combination thereof. For example, embodiments of the method for finding the K^{th} order element in a series of floating-point numbers may be implemented by a sort and select block. e.g., sort and select block 240.

In operation 1210, a sort and select block may receive or obtain a series of elements or values in floating-point format. e.g., each element or value in the series of elements or values may be one of a series of possible values supported by the floating-point number format. In this example, the size of each subblock is a byte, b=8, and the number of subblocks is four, a=4. An exemplary series 1300 of single-precision (SP) floating-point number format elements (referred to herein as a floating-point number) is provided in FIG. 13 (shown without the sign bit). The floating-point number 1300 may include 32 bits, arranged in a sign bit (bit 31) and four bytes, exponent byte 1302, including bits 30-23, mantissa high byte 1304, including bits 22-16 and a filler MSB bit with a value of ‘0’, mantissa middle byte 1306, including bits 15-8, and mantissa low byte 1308, including bits 7-0.

While the example is provided for a SP floating-point number format, this is not limiting and embodiments of the method may be adjusted for double-precision (DP) floating-point number format and other floating-point formats that share a similar structure as the SP floating-point number format, e.g., exp in the MSBs and mantissa in the LSBs, with the necessary adjustments.

In operation 1212, the sort and select block may select the exponent byte 1302 (e.g., the third byte) from each value of the series of values to generate a series of exponents. In operation 1214, the sort and select block may find a K^{th} order element of series of exponents, referred to herein as KStat_exp. According to some embodiments, the sort and select block may find the K^{th} order element using embodiments of the method for finding the K^{th} element in a series of values as disclosed herein with reference to FIG. 4. However, this is not limiting and any other sorter or method for finding the K^{th} order element may be used. In operation 1215, the sort and select block may find candidates for a second iteration in the series of floating-point numbers. For example, the sort and select block may find in the series of floating-point numbers, floating-point numbers with exponent byte 1322 that equals KStat_exp to generate a first series of candidates 1320, as presented in FIG. 13. Thus, all the elements in the first series of candidates 1320 may include exponent byte 1322 that equals KStat_exp. Other elements in the series of elements (elements that include an MSB byte that does not equal KStat_exp) may not be searched in further iterations.

In operation 1216, the number of candidates in the first series of candidates may be evaluated. If the number is small (e.g., smaller than a threshold number of candidates), embodiments of the method may continue to operation 1224 to sort the first series of candidates. After sorting the candidates, embodiments of the method may continue to operation 1036, to combine the combine the K, K′, K″ and K′″ (as required) and find the K^{th} element of the entire series of floating-point numbers 1300. If, however, the number of candidates is large (e.g., equals or above the threshold number of candidates), embodiments of the invention may continue to operation 1218 to extract, from the first series of candidates 1320, another subblock of bits, e.g., the next byte, e.g., the high byte of the mantissa 1324 (also referred to as the mantissa high byte) to generate a series of mantissa high bytes. In operation 1220, an adjusted K^{th} element (also referred to as the K′^{th} element or KStat_highBits) may be found among the series of mantissa high bytes. The value of the adjusted K (e.g., K′) may be determined by subtracting the number of elements in the series of elements having mantissa byte 1302 that is smaller than KStat_exp from K:

$${K}^{′} = K - ( number of elements with exponent byte < KStat\_EXP )$$

According to some embodiments, the sort and select block may find the K′^{th} order element in the first series of candidates 1320 using embodiments of the method for finding the K^{th} element in a series of values as disclosed herein with reference to FIG. 4. However, this is not limiting and any other sorter or method for finding the K′^{th} order element may be used.

In operation 1221, the sort and select block may find candidates for a third iteration in the first series of candidates 1320. For example, the sort and select block may find in the first series of candidates 1320 floating-point numbers with mantissa high byte 1344 that equals KStat_highBits to generate a second series of candidates 1340. Thus, all the elements in the second series of candidates 1340 may include exponent byte 1342 that equals KStat_exp and mantissa high byte 1344 that equals KStat_highBits. Other elements in the series of elements 1300 (elements that include exponent byte that does not equal KStat_exp and elements that include an exponent byte that equals KStat_exp and a mantissa high byte that does not equal KStat_highBits) may not be searched in further iterations.

In operation 1222, the number of candidates in the second series of candidates 1340 may be evaluated. If the number is small (e.g., smaller than a threshold number of candidates), embodiments of the method may continue to operation 1224 to sort the second series of candidates and find the K^{th} element of the entire series of floating-point numbers 1300. If, however, the number of candidates is large (e.g., equals or above the threshold number of candidates), embodiments of the invention may continue to operation 1226 to extract, from the second series of candidates 1340, another subblock of bits, e.g., the next byte. e.g., the mantissa middle byte 1346 to generate a series of mantissa middle bytes. In operation 1228, an adjusted K^{th} element (also referred to as the K″^{th} element or KStat_middleBits) may be found among the series of mantissa middle bytes. The value of the adjusted K (e.g., K″) may be determined by subtracting the number of elements in the first series of candidates having second byte 1344 that is smaller than KStat_middleBits from K′.

$${K}^{″} = {K}^{′} - ( number of elements in the first series of candidates with mantissa middle bytes < KStat\_middleBits )$$

According to some embodiments, the sort and select block may find the K″th order element in the second series of candidates 1340 using embodiments of the method for finding the K^{th} element in a series of values as disclosed herein with reference to FIG. 4. However, this is not limiting and any other sorter or method for finding the K″th order element may be used.

In operation 1329, the sort and select block may find candidates for a fourth and last iteration in the second series of candidates 1340. For example, the sort and select block may find in the second series of candidates 1340 floating-point numbers with mantissa middle bytes that equals KStat_middleBits to generate a third series of candidates 1360. Thus, all the elements in the third series of candidates 1360 may include exponent byte 1362 that equals KStat_exp, mantissa high byte 1364 that equals KStat_highBits and mantissa middle byte 1366 that equals KStat_middleBits. Other elements in the series of elements 1300 may not be searched in the fourth iteration.

In operation 1230, the number of candidates in the third series of candidates 1360 may be evaluated. If the number is small (e.g., smaller than a threshold number of candidates), embodiments of the method may continue to operation 1224 to sort the second series of candidates 1340 and find the K^{th} element of the entire series of floating-point numbers 1300. If, however, the number of candidates is large (e.g., equals or above the threshold number of candidates), embodiments of the invention may continue to operation 1232 to extract, from the third series of candidates 1360, another subblock of bits, e.g., the next byte. e.g., the mantissa low byte 1368 to generate a series of mantissa low bytes. In operation 1234, an adjusted K^{th} element (also referred to as the K′″^{th} element or KStat_lowBits) may be found among the series of mantissa low bytes. The value of the adjusted K (e.g., K′″) may be determined by subtracting the number of elements in the second series of candidates 1360 having mantissa middle byte 1366 that is smaller than KStat_middleBits, from K″.

$${K}^{″} = \text{} {K}^{″} - ( number of elements in the second series of candidates with mantissa middle bytes < KStat\_middleBits )$$

According to some embodiments, the sort and select block may find the K′″^{th} order element in the third series of candidates using embodiments of the method for finding the Kth element in a series of values as disclosed herein with reference to FIG. 4. However, this is not limiting and any other sorter or method for finding the K′″^{th} order element may be used.

In operation 1236, the sort and select block may combine the K, K′, K″ and K′″ to find or obtain the general K^{th} order element. For example, the sort and select block may select the element for which the exponent byte 1302 equals KStat_exp, mantissa high byte 1304 equals KStat_highBits, mantissa middle byte 1306 equals KStat_middleBits, and mantissa low byte 1308 equals KStat_lowBits.

Reference is made to FIG. 14, which is a schematic illustration of an exemplary device according to embodiments of the invention. A device 1400 may include a computer device having a wireless communication capabilities, including for example, a OS-CFAR detector. e.g., OS-CFAR detector 122 located in receiver 120. Device 1400 may include any device capable of executing a series of instructions, for example for performing embodiments of the methods disclosed herein. Device 1400 may include an input device 1460 such as a mouse, a receiver, a keyboard, a microphone, a camera, a Universal Serial Bus (USB) port, a compact-disk (CD) reader, any type of Bluetooth input device, etc., and an output device 1470, for example, a transmitter or a monitor, projector, screen, printer, speakers, or display.

Device 1400 may include a processor 1410. Processor 1410 may include or may be a vector processor, a central processing unit (CPU), a digital signal processor (DSP), a microprocessor, a controller, a chip, a microchip, a field-programmable gate array (FPGA), an application-specific integrated circuit (ASIC) or any other integrated circuit (IC), or any other suitable multi-purpose or specific processor or controller.

Device 1400 may include a memory unit 1420. Memory unit 1420 may be or may include any of a short-term memory unit and/or a long-term memory unit. Memory unit 1420 may include, for example, random access memory (RAM), dynamic RAM (DRAM), flash memory, volatile memory, non-volatile memory, a tightly-coupled memory (TCM), a buffer, a cache, such as an L-1 cache and/or an L-2 cache, or other suitable memory units or storage units. Memory unit 1420 may be implemented as separate (for example, “off-chip”) or integrated (for example, “on-chip”) memory unit, or as both.

Processor 1410 may request, retrieve, and process data from memory unit 1420 and may control, in general, the pipeline flow of operations or instructions executed on the data. Processor 1410 may receive instructions, for example, from a program memory (for example, in memory unit 1420 to perform methods disclosed herein. According to embodiments of the present invention, processor 1410 may receive instructions to decoding a received signal in a MIMO communication system including a preprocessing stage, according to embodiments of the invention.

Embodiments of the invention may be implemented for example on an integrated circuit (IC), for example, by constructing processor 1410, as well as other components of FIG. 14 in an integrated chip or as a part of an chip, such as an ASIC, an FPGA, a CPU, a DSP, a microprocessor, a controller, a chip, a microchip, etc.

According to embodiments of the present invention, some units e.g., processor 1410, as well as the other components of FIG. 14, may be implemented in a hardware description language (HDL) design, written in Very High Speed Integrated Circuit (VHSIC) hardware description language (VHDL), Verilog HDL, or any other hardware description language. The HDL design may be synthesized using any synthesis engine such as SYNOPSYS® Design Compiler 2000.05 (DC00), BUILDGATES® synthesis tool available from, inter alia. Cadence Design Systems. Inc. An ASIC or other integrated circuit may be fabricated using the HDL design. The HDL design may be synthesized into a logic level representation, and then reduced to a physical device using compilation, layout and fabrication techniques, as known in the art.

Embodiments of the present invention may include a computer program application stored in non-volatile memory, non-transitory storage medium, or computer-readable storage medium (e.g., hard drive, flash memory. CD ROM, magnetic media, etc.), storing instructions that when executed by a processor (e.g., processor 1410) carry out embodiments of the invention. Processor 1410 may be configured to carry out embodiments described herein by for example executing software or instructions.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM. ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented which achieve the same or similar functionality.

1. A method for finding a K^{th} element in a series of values, the method comprising, using a processor:
organizing the series of values in a probability distribution histogram by finding a number of occurrences of each value of the series of values;
organizing the series of values in a decimated accumulated histogram, wherein the decimated accumulated histogram includes adjacent bins of ranges of values;
performing a coarse search on the decimated accumulated histogram; and
performing a fine search in the probability distribution histogram, based on results of the coarse search.

2. The method of claim 1, wherein organizing the series of values in the decimated accumulated histogram comprises finding for each bin an accumulated number of occurrences of values of the series of values up to a bin index of that bin, wherein the bin index is a maximal value included in the bin;
wherein performing the coarse search on the decimated accumulated histogram comprises finding in the decimated accumulated histogram a bin for which the associated accumulated number of occurrences is a largest accumulated number of occurrences among the accumulated number of occurrences that is smaller than K; and
wherein performing the fine search in the probability distribution histogram comprises searching the probability distribution histogram for the K^{th} smallest element, starting from the bin index of the found bin.

3. The method of claim 1, wherein organizing the series of values in the decimated accumulated histogram comprises finding for each bin, an accumulated number of occurrences of values of the series of values down to a bin index of that bin, wherein the bin index is a minimal value included in the range of values of the bin;
wherein performing the coarse search on the decimated accumulated histogram comprises finding in the decimated accumulated histogram a bin for which the associated accumulated number of occurrences is a largest accumulated number of occurrences among the accumulated number of occurrences that is smaller than K; and
wherein performing the fine search in the probability distribution histogram comprises searching the probability distribution histogram for the K^{th} largest element, starting from the bin index of the found bin.

4. The method of claim 1, wherein the bins of the decimated accumulated histogram are equally spaced.

5. The method of claim 1, wherein the bins of the decimated accumulated histogram are spaced based on a-priory knowledge of statistics of the series of values.

6. The method of claim 1, wherein the series of values comprises values of a window of an ordered-statistic constant false-alarm rate (OS-CFAR) detector, the method comprising using the K^{th} element to detect targets by the OS-CFAR detector.

7. The method of claim 6, wherein the bins are spaced based on the K^{th} element, and a distribution of the series of values of previous OS-CFAR windows.

8. The method of claim 1, wherein a format of the values of the series of values is unsigned 8-bit integer.

9. The method of claim 1, comprising:
obtaining a second series of values;
selecting a subblock of bits of each value of the second series of values to generate a narrow series of values;
finding a first K^{th} largest element of the narrow series of values;
repeating the selecting and finding until a required precision in finding a general K^{th} order element is achieved; and
combining the K^{th} largest elements to obtain the general K^{th} largest element.

10. The method of claim 1, comprising:
obtaining a series of unsigned integers, each of a*eight bits, wherein a is an integer larger than 1;
performing a log₂ operation on the series of the unsigned integers and extracting an integer part of the result to obtain a first series of values,
finding a first K^{th} largest element of the first series of values to obtain KStat_exp;
scaling the series of unsigned integers by shifting left with saturation each of the unsigned integers by KStat_exp to obtain a shifted series;
extracting eight most significant bits (MSBs) of the shifted series;
finding a second K^{th} largest element for the MSBs of the shifted series to obtain KStat_HighBits; and
approximating a general K^{th} smallest element of the series of unsigned integers by calculating KStat_HighBits*2^{KStat_exp+exp_bias}.

11. The method of claim 1, comprising:
obtaining a series of floating-point numbers;
extracting an exponent of each of the floating-point numbers of the series of floating-point numbers to obtain a series of exponents;
finding a first K^{th} smallest element of the series of exponents to obtain KStat_exp;
finding in the series of floating-point numbers floating-point numbers with exponent of KStat_exp;
extracting a set of most significant bits (MSBs) of a mantissa of the floating-point numbers with exponent of KStat_exp to generate a series of MSBs;
finding a second K^{th} smallest element of the series of MSBs to obtain KStat_HighBits; and
approximating a general K^{th} smallest element of the series of floating-point numbers by calculating KStat_HighBits*2^{KStat_exp+exp_bias}.

12. The method of claim 11, wherein the set of MSBs comprises eight bits.

13. The method of claim 1, comprising:
obtaining a series of unsigned integers, each of a*b bits, wherein a and b are integer numbers larger than 1;
extracting a subblock of b most significant bits (MSBs) of each unsigned integer of the series of unsigned integers to obtain a series of MSBs;
finding a first K^{th} smallest element of the series of MSBs to obtain KStat_MSB;
finding in the series of unsigned integers, unsigned integers with MSBs that equal KStat_MSB to generate a series of candidates; and
repeating for each consecutive subblock of b bits of the unsigned integers:
if the series of candidates include a number of unsigned integers that is below a threshold than:
performing a linear search on the series of candidates to find a general K^{th} smallest element of the series of unsigned integers;
otherwise:
extracting a subblock of b bits following the previous extracted subblock of b bits of each integer of the series of candidates to obtain a series of subblocks;
finding a following K^{th} smallest element of the series of subblock to obtain KStat_subblock; and
if the extracted subblock includes the least significant bits (LSB), combining the KStat_MSB with the KStat_subblocks to generate the general K^{th} smallest element of the series of unsigned integers and otherwise leaving in the series of candidates, only candidates with the subblock of b bits that equals KStat_subblock.

14. A method for finding a K^{th} order element in a series of values, the method comprising, using a processor:
extracting a subblock of bits from each value of the series of values to generate a narrow series of values;
finding a first K^{th} order element of the narrow series of values;
repeating the extracting and finding until a required precision in finding a general K^{th} order element is achieved; and
combining the first K^{th} order elements to obtain the general K^{th} order element.

15. The method of claim 14, wherein:
the elements of the series of values are provided in unsigned integer format;
wherein in a first repetition:
selecting comprises performing a log₂ operation on the series of the unsigned integers and extracting an integer part of the result to obtain the first narrow series of values;
and finding the first K^{th} largest element of the first narrow series of values is performed to obtain KStat_exp;
wherein in a second repetition:
selecting comprises scaling the series of unsigned integers by shifting left with saturation each of the unsigned integers by KStat_exp to obtain a shifted series; and
extracting a plurality of most significant bits (MSB) of the shifted series;
and wherein finding a second K^{th} largest element for the MSB of the shifted series is performed to obtain a second KStat_HighBits;
wherein combining comprises approximating a general K^{th} largest element of the series of unsigned integers by calculating KStat_HighBits*2^{KStat_exp+exp_bias}.

16. The method of claim 14, wherein:
the series of values comprises a series of floating-point numbers;
wherein in a first repetition:
selecting comprises extracting an exponent of each of the floating-point numbers of the series of floating-point numbers to obtain a series of exponents;
and finding a first K^{th} largest element of the series of exponents is performed to obtain a first KStat_exp;
wherein in a second repetition:
selecting comprises finding in the series of floating-point numbers floating-point numbers with an exponent equal to KStat_exp, and extracting a set of most significant bits (MSB) of a mantissa of the floating-point numbers with exponent of KStat_exp to generate a series of MSBs;
and finding a second K^{th} largest element of the series of MSBs is performed to obtain a second KStat_HighBits;
wherein combining comprises approximating a general K^{th} largest element of the series of floating-point numbers by calculating KStat_HighBits*2^{KStat__exp+exp_bias}.

17. The method of claim 14, wherein the set of MSBs comprises eight bits.

18. The method of claim 14, wherein:
the series of values comprises unsigned integers, each of a*b bits, wherein a and b are integer numbers larger than 1;
wherein in a first repetition:
selecting comprises extracting a subblock of b most significant bits (MSB) of each unsigned integer of the series of unsigned integers to obtain a series of MSBs;
and finding a first K^{th} largest element of the series of MSBs is performed to obtain KStat_MSB;
wherein the method further comprising finding in the series of unsigned integers, unsigned integers with MSBs that equal KStat_MSB to generate a series of candidates; and
if the series of candidates include a number of unsigned integers that is below a threshold than: performing a linear search on the series of candidates to find a general K^{th} largest element of the series of unsigned integers; and
otherwise, repeating the selecting and finding comprises repeating for each consecutive subblock of b bits of the unsigned integers:
extracting a byte following the previous extracted subblock of b bits of each integer of the series of candidates to obtain a series of subblocks of b bits;
finding a following K′^{th} largest element of the series of subblock of b bits to obtain KStat_subblock; and
if the extracted byte includes the least significant bits (LSB), combining the KStat_MSB with the KStat_subblocks to generate the general K^{th} largest element of the series of unsigned integers and otherwise leaving in the series of candidates, only candidates with MSB that equal KStat_subblock.

19. The method of claim 14, wherein finding the first K^{th} largest element in the narrow series of values, comprises:
organizing the narrow series of values in a histogram by counting a number of occurrences of each value of the narrow series of values;
organizing the narrow series of values in a decimated accumulated histogram, wherein the decimated accumulated histogram includes adjacent bins of ranges of values, and wherein organizing the narrow series of values comprises counting for each bin an accumulated number of occurrences of values of the narrow series of values up to a bin index, wherein the bin index is a maximal value included in the bin;
finding in the decimated accumulated histogram a bin for which the associated accumulated number of occurrences is a largest accumulated number of occurrences among the accumulated number of occurrences that is smaller than K; and
searching the histogram for the K^{th} element, starting from the found bin index.

20. The method of claim 19, wherein the bins are equally spaced.

21. The method of claim 19, wherein the bins are spaced based on a-priory knowledge of a possible range of the K^{th} largest element.

22. The method of claim 14, wherein the series of values comprises values of an ordered-statistic constant false-alarm rate (OS-CFAR) window of a detector, the method comprising using the K^{th} largest element to detect targets by the OS-CFAR detector.

23. The method of claim 14, wherein a format of the values of the narrow series of values is unsigned 8-bit integer.
